(19) United States
(12) Patent Application Publication
(10) Pub. No.: US 2011/0145114 A1
(43) Pub. Date: Jun. 16, 2011

(54) COMPUTER IMPLEMENTED SYSTEM FOR SELF-MANAGED INCENTIVE PROGRAM

(76) Inventors: Robert Purdy, Uxbridge (CA); Tim Mirecki, Markham (CA); Philip Daly, Whitby (CA)

(21) Appl. No.: 12/679,920

(22) PCT Filed: Sep. 25, 2008
(86) PCT No.: PCT/CA2008/001697

§ 371 Date: Dec. 3, 2010

Related U.S. Application Data
(60) Provisional application No. 60/975,004, filed on Sep. 25, 2007.
(60) Provisional application No. 61/031,867, filed on Feb. 27, 2008.

(51) Int. Cl. G06Q 30/00; G06F 21/00

(52) U.S. Cl. 705/34; 726/4; 705/1.1

(57) ABSTRACT

This invention is directed to a computer implemented system and method for enabling a user to create a self-managed incentive program. A provider system coupled to a communication network is provided for access by a plurality of authorized users associated with a plurality of client organizations. A hierarchy module having a plurality of information fields to be completed by a user, the information fields including fields for receiving data concerning the user's personnel and divisions, an incentive program module that allows a user to establish one or more incentive programs in respect to the personnel and divisions in accordance with user selected criteria. The hierarchy module and the incentive program module are operated by a corporate user without the requirement for assistance of a system provider.

### FIELD OF THE INVENTION

The invention generally relates to computer implemented incentive programs and more specifically to computer implemented incentive programs that are self-managed.

### BACKGROUND OF THE INVENTION

Incentive programs, and computer implemented incentive programs are well known in today's corporate culture. Such programs are often provided to corporate clients by a service provider or system operator. Such system operator charges the client a fee that allows the system operator to recover costs related to their system, and also make a profit.

A large portion of the costs that a system operator needs to recover arise out of system set-up for each client, data entry, incentive program specification, system and data updating, and invoicing. For each new client, a system operator may have to meet with the client at least to understand their corporate structure and obtain employee names, titles and position in the corporate structure, as well as to obtain details about the one or more incentive programs that may be offered to one or more divisions in the corporation. All of these details and data must then be added to the system by the system operator, and the desired incentive programs must be created. If any of these details change, as they often do, the system operator must enter such changes to keep the system updated for each client. Implementation of simple and complex sales incentive programs requires extensive design, development and quality assurance work. Further, the system operator must create and send invoices, and receive payments for those invoices, for each client. This all involves significant time and effort by the system operator and can result in large fees to be paid by corporate clients.

Although system operators want to charge significant fees to increase profit, they also generally want to satisfy customers and reduce costs. By reducing the above costs, the fee can be reduced without decreasing profit. Therefore, although incentive programs are known, there exists a need for a sophisticated incentive program that reduces or eliminates costs to the system operator and is administrable largely by corporate clients.

### SUMMARY OF THE INVENTION

In one aspect of the invention there is a computer implemented system offered by a provider for enabling authorized users from a plurality of client organizations to create and manage incentive programs that are specific to each client organization, the system comprising: a provider system coupled to a communication network for access by a plurality of authorized users associated with a plurality of client organizations; a hierarchy module for receiving and managing information from authorized users concerning the organizational structure of each client organization; and an incentive module for receiving and managing information from authorized users concerning one or more incentive programs for each client organization.

The hierarchy module may include information fields that may comprise divisions, division leaders, division employees, division employees' titles and division location. The incentive module may include user selected criteria that may comprise a title, reward structure, maximum reward per employee, maximum reward for the program, divisions participating in the program, overseer of the program and duration of the program. The corporate user may specify one or more information fields and one or more user selected criteria. The corporate user may give permission to a second corporate user to specify a further one or more information fields and one or more of the user selected criteria. The second corporate user may be a division leader or an overseer of the program.

The corporate user may access the system, including the hierarchy and the incentive program module, from a user computer that communicates over a network to a system provider computer. The system may further comprise an automated invoicing module for automatically issuing electronic invoices based on predefined criteria relating to a user's use of incentive program.

The automated invoicing module may only allow a issuance of a number of points corresponding to an invoice amount determined by the corporation's credit check. The automated invoicing module may send an electronic invoice via email or fax. The corporate user may access the incentive program module and the automated invoicing module via their interfaces, from a user computer that communicates over a network to a system provider computer. The payment and the automated invoicing module, via its interface, may present the corporate user an invoice and allow a corporate user to provide electronic payment information to satisfy the invoice.

In another aspect of the invention there is a method for a provider to enable authorized users from a plurality of client organizations to create and manage incentive programs that are specific to each client organization, comprising the steps of: providing a provider system coupled to a communication network for access by a plurality of authorized users associated with a plurality of client organizations; providing a hierarchy module for receiving and managing information from authorized users concerning the organizational structure of a client organization and providing an incentive module for receiving and managing information from authorized users concerning one or more incentive programs for a client organization.

### BRIEF DESCRIPTION OF THE DRAWINGS

FIG. 1 is a block diagram of a system in accordance with an embodiment of the present invention.

FIGS. 2-3 are diagrams of modules of a system in accordance with an embodiment of the present invention.

FIG. 4 is a flowchart for creation of a new account for a system in accordance with an embodiment of the present invention.

FIG. 5 is a flowchart for creation of administrator users in accordance with an embodiment of the present invention.

FIG. 6 is a flowchart for establishing incentive program criteria and issuing incentives in accordance with an embodiment of the present invention.

FIGS. 7-10 are flowcharts and screens for operation of a hierarchy module in accordance with an embodiment of the present invention.

FIGS. 11-16 are flowcharts and screens for operation of a member enrollment module in accordance with an embodiment of the present invention.

FIGS. 17-21 are flowcharts and screens for operation of an invoicing module in accordance with an embodiment of the present invention.

FIGS. 22-24 are flowcharts for establishing sales incentive program criteria in accordance with embodiments of the present invention.

### DETAILED DESCRIPTION OF THE INVENTION

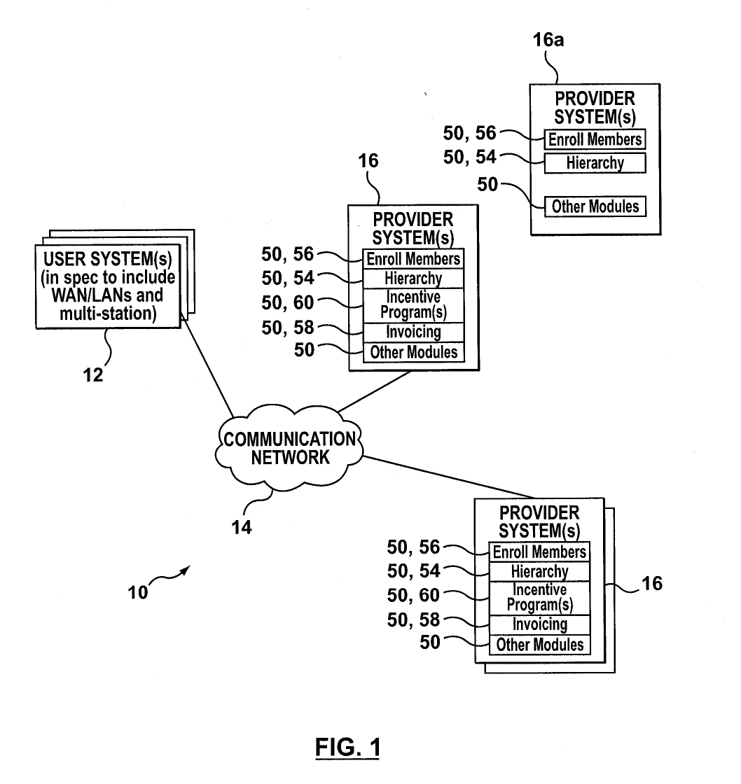

FIG. 1 is a block diagram of a computer implemented system 10 for a self-managed incentive program (“system” 10) in accordance with an embodiment of the present invention. System 10 comprises user system(s) 12, communication network 14, and one or more provider system(s) 16.

System 10 may provide incentive programs to users, and may further provide other functionality, as described herein. Such other functionality may include, for example, weather and news feeds, blogs, classified postings, human resources information, or any other information that may commonly form part of a corporate intranet. System 10 may actually replace, or may augment, a corporate intranet.

System 10 allows a system provider to provide access to system 10 to a client; this allows a client to access components of system 10 (such as provider 16) via other components (such as user system 12) that may implement functionality of system 10 described herein, such as in the various methods and flowcharts herein that are implemented for example by various screens stored or created on provider system 16 and interacted with at user system 12. After providing such access, a system provider may require limited, or substantially zero, administrative time or effort to implement, oversee, and invoice the client. A client may be able to input their organizational or corporate structure including divisions, branches, groups, or any other desired structure, into system 10 without any assistance from a system provider. A client may further be able to add one or more administrators, for one or more divisions, and allow them access to one or more incentive programs or other functionality of system 10. A client may be able to limit, or apply criteria, to one or more administrators' abilities to offer incentive programs and issue rewards. A client, or administrator, may add or enroll members, into one or more of such divisions, manually or automatically. In each case, no assistance from the system provider is required, though such assistance is possible. System 10 may issue invoices to one or more clients. Invoicing may be done at pre-determined times, when a client requests to receive an invoice, by a system provider sending an invoice, or at any other time as desired by system 10, a system provider, or a client.

As shown in FIG. 1, system 10 comprises user system(s) 12, communication network 14, and provider system 16. In such an embodiment, user system(s) 12 interacts with provider system 16 over communication network 14. In one embodiment of FIG. 1, communication network 14 may be the Internet, and provider system 16 is a web server hosting a website that user system(s) 12 access. In a further embodiment, system 10 may be a client/server model and system 10 may operate substantially at a client site. In such an embodiment, provider system 16 may be at a client site, communication network 14 maybe a local area network (LAN) or wide area network (WAN) that may be a client's private network. User system(s) 12 could then be one or more personal computers (PCs) that run client applications to access provider system 16 that operates like a server application. It is to be understood that further embodiments for implementing system 10 are possible and are considered within the scope of the present invention.

As used herein, client may refer to an individual or entity that is utilizing the system to implement an incentive program of a corporation, company, organization, one or more users or members, or some other such client. Such terms are used interchangeably throughout this application and only have particular meaning if further discussed in a particular context.

As used herein, system provider refers to the individual or entity of this provider system 16, and may be referred to as a system operator, provider, or service provider. Such terms are used interchangeably throughout this application and only have particular meaning if further discussed in a particular context.

User system(s) 12 may allow one or more users to access a computer implemented system for self-managed incentive programs having various functionality including, for example, creation of accounts and programs, awarding of points, redeeming points, invoicing information, and all other modules, functionality, or methods described with respect to various flowcharts or as described herein. Different users may be provided different access. By way of example, a “superadministrator” may have access to all modules or functionality that the client has access to. An “administrator user” may have access to a subset of the superadministrator's modules, while a “regular user” may have access to a subset of one or more administrator's accessible modules.

User system(s) 12 may have user interface (UI) components (not shown in FIG. 1) associated therewith, for example screens, that allow user system(s) 12, and a particular user, to interact with system 10 for example to effect any of the methods with respect to various flowcharts or as described herein. Exemplary screens for user system(s) 12 are provided and described herein, though any screens may be used for user system(s) 12 provided the desired functionality is provided.

User system(s) 12 may allow multiple users from the same organization or company to access the system at the same or different times, using the same or different devices. User system(s) 12 may be a personal computer (PC), personal digital assistant (PDA), cellphone, or other computing device, that allows access, or operation of, system 10. User system(s) 12 may be one or more systems that may be connected together via a LAN, WAN or other network, which may the same as or separate from, communication network 14.

Communication network 14 allows communication between user system(s) 12 and provider system 16 and may allow communication between different users or portions of user system(s) 12 or between aspects of provider system 16. Communication network may be any form of LAN or WAN, including, but not limited to a wireless communication network, the Internet, an 802.11b network, Bluetooth network, or any other network.

Provider system 16 executes at least a portion of system 10 and may include substantially all modules to implement the functionality of system 10, such as the methods described with respect to various flowcharts, as disclosed and described herein. As shown in FIG. 1 and described herein, such modules may include enroll members module 50, 56, hierarchy module 50, 54, incentive program module 50, 60 and invoicing module 50, 58 and other modules 50. These modules may be interoperable or may be the same module and may allow development of multiple programs and incentives from one or more user systems 12.

Provider system 16 may be one or more personal computers or servers and may operate in combination, such as in distributed computing or the like, and may be local to one another, operably connected, remote or any combination thereof.

As shown at provider system 16a, 16b, the functionality of provider system 16 can be distributed between one or more provider systems 16a, 16b. Each of provider systems 16a, 16b may offer all of the functionality of provider system 16 or they may rely on each other to provide the full functionality of provider system 16. By way of example, provider system 16a may be located in one geographic location and provide all functionality of provider system 16. Provider system 16b may be remote from, but operably connected to, provider system 16a and may rely on some functionality of provider system 16a (such as for incentive programs module 50, 60 and invoicing module 50, 58). In such architecture, provider system 16a may be the primary provider system 16a and one or more provider systems 16b may be secondary provider systems 16 that may be operated by the same party or an independent party from provider system 16a. This may allow a provider to take advantage of strategic business arrangements such as resellers, independent operators, or franchising.

Provider system 16 may store at least some of the data related to system 10, such as users' information, corporate information, incentive program information, or other information may be part of a corporate intranet. Provider system 16 may be a server or PC, for example a web server, and its hardware may be substantially similar to user system(s) 12. Provider system 16 may be remote from or local to user system(s) 12 and may be operated by the client that runs user system(s) 12.

It is to be understood that the architectures for user system 12 and provider system 16 are exemplary only. Many different configurations, involving for example hardware and software, and methods of operating, are possible and considered within the scope of the present invention.

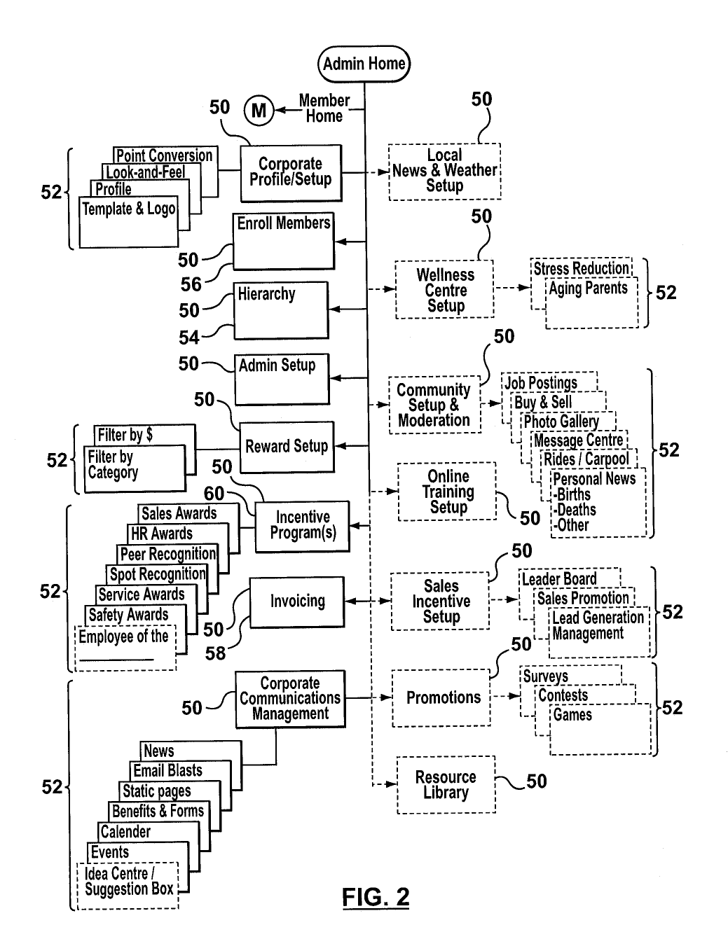

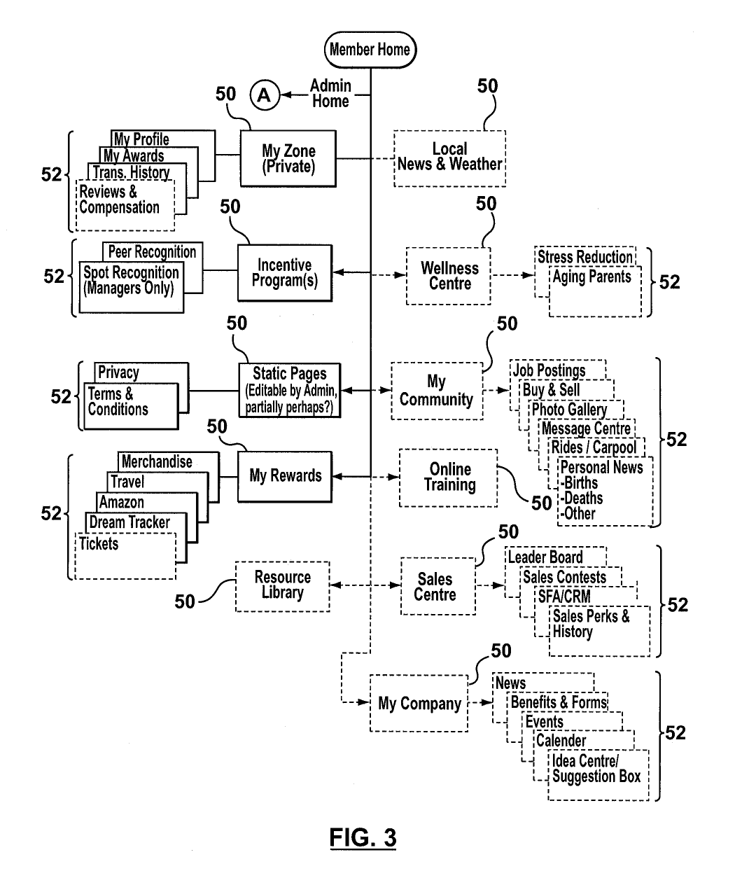

FIGS. 2-3 are diagrams of modules 50 of a system in accordance with an embodiment of the present invention. In particular, FIG. 2 shows modules 50 that a superadministrator or an administrator may be able to access and use, while FIG. 3 shows modules 50 that an enrolled member or user may be able to access and use.

Referring specifically to FIG. 2, exemplary modules 50 of system 10 include: a Corporate Profile/Setup module which may include sub-modules such as Point Conversion, Look-and-Feel, Profile and Template & Logo, an Enroll Members module 56, a Hierarchy module 54, an Admin Setup module, a Reward Setup module which may include sub-modules such as Filter by Money and Filter by Category, an Incentive Program(s) module 60 which may include sub-modules such as Peer Recognition, Spot Recognition, Service Awards, Safety Awards and Employee of the Month (or other period), an Invoicing Module 58, a Corporate Communications Management module which may include sub-modules such as News, Email Blasts, Static Pages, Benefits & Forms, Calendar, Events and Idea Centre/Suggestion Box, a Local News & Weather Setup module, a Wellness Centre Setup module which may include sub-modules such as Stress Reduction and Aging Parents, a Community Setup & Moderation module which may include sub-modules such as Job Postings, Buy & Sell, Photo Gallery, Message Centre, Rides/Carpool and Personal News, an Online Training Setup module, a Sales Incentive Setup module which may include sub-modules such as Leader Board, Sales Promotions and Lead Generation Management, a Promotions module which may include sub-modules such as Surveys, Contests and Games, and a Resource Library module.

Referring specifically to FIG. 3, exemplary modules 50 of system 10 include: a My Zone (Private) module which may include sub-modules such as My Profile, My Awards, Trans. History and Reviews & Compensation, an Incentive Program(s) module which may include sub-modules such as Peer Recognition and Spot Recognition, a Static Pages module which may include sub-modules such as Privacy and Terms & Conditions, a My Rewards module which may include sub-modules such as Merchandise, Travel, Amazon, Dream Tracker and Tickets, a Recourse Library module, a Local News & Weather module, a Wellness Centre module which may include sub-modules such as Stress Reduction and Aging Parents, a My Community module which may include sub-modules such as Job Postings, Buy & Sell, Photo Gallery, Message Centre, Rides/Carpool and Personal News, an Online Training module, a Sales Centre module which may include sub-modules such as Leader Board, Sales Contests, SFA/CRM and Sales Perks & History, and a My Company module which may include sub-modules such as News, Benefits & Forms, Events, Calendar and Idea Centre/Suggestion Box.

Modules 50 may be part of provider system 16 that allows a user, or a system operator to access functionality of module 50 via user system(s) 12.

The particular modules 50 as shown in FIGS. 2-3 are intended as exemplary only, many other modules may be included in system 10. It is to be understood that modules 50 may be combined to provide the functionality of multiple modules 50 in one module 50. By way of example, hierarchy module 50, 54 may provide the functionality of member enrollment module 50, 56.

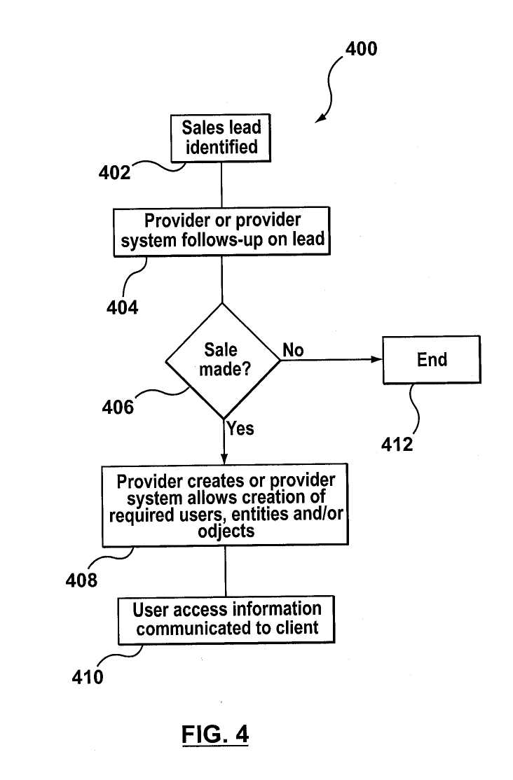

FIG. 4 (New Account Creation) is a flowchart for creation of a new account for a system 10 in accordance with an embodiment of the present invention.

Process 400 allows creation of accounts, which may involve creating one or more new corporate entities, clients or users, and may involve creation of a superadministrator. A system operator may completely or partially perform process 400. Alternatively, a client or superadministrator may completely or partially perform process 400 themselves.

Process 400 may be substantially the only process that involves the system operator. Although a system operator may be required to create a new account or otherwise provide a new client access to system 10 (as in process 400), such as by creation of a superadministrator, they may not need to otherwise be involved. A super administrator from a corporation may completely run and administer system 10 for that corporation. As such, system 10 may be substantially self-managed or may be completely self-managed if a client wishes, the system operator may provide extra support or assistance in administering or running system 10 though they may be charged extra.

Process 400 begins at 402 where a sales lead is identified. The sales lead may be identified, for example, after the lead interacted with provider system 16. This may include filling out a contact form on, for example, a web page-viewed or accessed on user system 12. Alternatively, the system operator may communicate in another way with a sales lead or potential client.

At 404 the system operator or provider, or provider system 16, follows up on the sales lead that was identified at 402. This may be, for example, by an email, a phone call or any other form of communication.

At 406 if a sale is made, process 400 proceeds to 408 where the provider creates or where the provider system allows account creation. This may be accomplished, for example, by creating one or more corporation or superadministrator objects, users or profiles. This may involve entering, for example at provider system 16 or user system 12, some information, such as a corporate name, superadministrator name and contact information.

The creation of such objects, entities and profiles may be done by the system operator, the client or corporate entity. It is further possible that other objects and user profiles may be created at 408, such as inputting an organizational structure (as described herein). Creation of other objects and the like may depend on the amount of administering the corporation or client wants the system operator to undertake. Additional administering by the system operator may increase costs and hence may not be desirable for the client.

At 410 user access information is communicated to the client for example by provider system 16, optionally automatically once the required information has been entered. This access information may be communicated, for example, to a superadministrator that was created. The superadministrator may receive this information via email, phone call, letter, or any other form of communication. Such access information may allow the super administrator to access system 10 to continue setting up system 10 for their corporation, and may include a login ID and password.

If no sale is made at 406, or user access information is communicated to the client at 410, process 400 ends at 412.

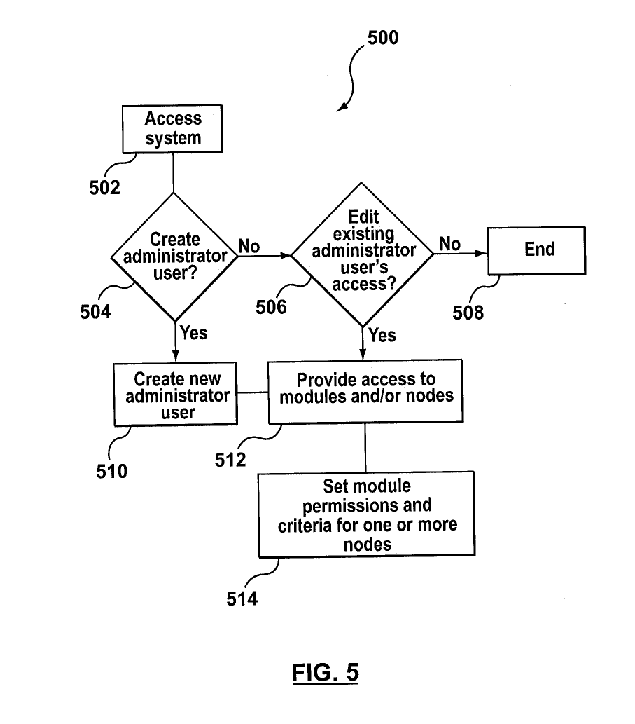

FIG. 5 (Permission Editor) is a flowchart for creation of administrator users in accordance with an embodiment of the present invention.

Process 500 allows creation of one or more administrator users, and for providing them access to specific modules 50, sub-modules 52 and establishing criteria related thereto. For example, process 500 allows providing one or more administrator users access to the incentive program module, one or more incentive programs and establishing criteria therefor. Modules 50 and sub-modules 52 may be chosen, for example, from those shown in FIGS. 2-3, or any other modules 50 or sub-modules 52. Process 500 may be undertaken by a superadministrator or another object or entity that is created in process 400 at 408, and may be effected with user system 12 accessing provider system 16.

Process 500 begins at 502 as system 10 is accessed. Accessing system 10 at 502 may involve logging into system 10, such as via entering a user name and password on user system 12 and providing it to provider system 16, or may simply involve running client software on user system 12. Login screens or windows, as known to those of the skill in the art, may be used. Accessing system 10 may further be by any other method known in the art. A superadministrator, an administrator, or a system operator, may access system 10 at 502.

Process 500 continues at 504 with a query whether to create an administrator user. If no administrator user is to be created then process 500 continues at 506 with a query whether to edit an existing administrator user's access or other characteristics. If no editing is to occur then process 500 terminates at 508.

Returning to 504, if an administrator user is to be created then process 504 continues at 510 where a new administrator user is created. Creating a new administrator user may involve providing details about that new administrator user, such as a user name, a password, one or more divisions of the corporation, contact information, and any other information required to establish a new user or administrator user. Such creation may be substantially similar to creating a superadministrator, such as at 408 of process 400. The new administrator user can be saved, such as in storage at provider system 16, with the information added at 510.

Process 500 then continues at 512 where the newly created administrator user may be provided access to modules 50 and sub-modules 52. A lookup table may be used and maintained that indicates whether a particular administrator has access to any given module 50 in system 10. At 512 a superadministrator, or simply an administrator, may provide access to one or more nodes (divisions or departments) and may further specify that a particular user is an administrator for one or more nodes. Specifying administrative responsibilities for one or more nodes, at 512, may occur along with specifying what modules 50 and sub-modules 52 are available.

Access may be provided to a module 50 if, for example, the administrator user is in one or more divisions that uses the module, is a senior member of a division or is high enough in the organizational structure of the corporation to access such module 50. By way of example, a module 50 may contain confidential information that only executives are allowed to access. Other reasons for providing access only to certain modules are considered within the scope of the present invention.

After providing access to modules 50 and sub-modules 52 at 512, process 500 continues at 514 where module permissions and criteria are set._Such setting may occur by user system 12 accessing screens stored at provider system 16, and the permissions and criteria may be stored at provider system 16. At 514, sub-module 52 access may be established for each administrator user. Such permission may be, for example, to allow access to various incentive programs (which may be sub-modules of the incentive program module). By way of example, an administrator user may be a manager of a sales department who at 512 is provided access to the incentive program module. At 514 the sales manager administrator user may be given permission to access incentive programs relating to sales, but not incentive programs relating to marketing or human resources.

Further, at 514, module or sub-module criteria may be specified. This may allow a superadministrator to specify a name for an incentive program, add budgetary details or constraints, or specify other criteria. This may be done for each of the one or more nodes that a particular user (such as an administrator or superadministrator) has access to, or is an administrator of.

By way of example, budgetary details may allow an administrator to apply a budget and other details for one or more nodes for one or more incentive programs. This may include setting a maximum reward per employee or division, how many awards, points, or dollars in total may be awarded, a start and end date for the incentive program, and an employee or user responsible for the incentive program. The administrator or superadministrator may be given a number of points that they may wish to apportion between, for example, nodes, divisions, departments, incentives programs, time periods, or employees. At 514, they may be able to do this, and alter their previous selections, at any time.

Other criteria, for other modules, may include the ability to view confidential information to a certain level of confidentiality, undergo evaluation or testing relating to employment, or other criteria for other modules. Returning to the example of a sales manager administrator user, at 514 a superadministrator may set criteria that a sales manager administrator user may issue a maximum of 10,000 points to the salesperson making the most sales for a given month.

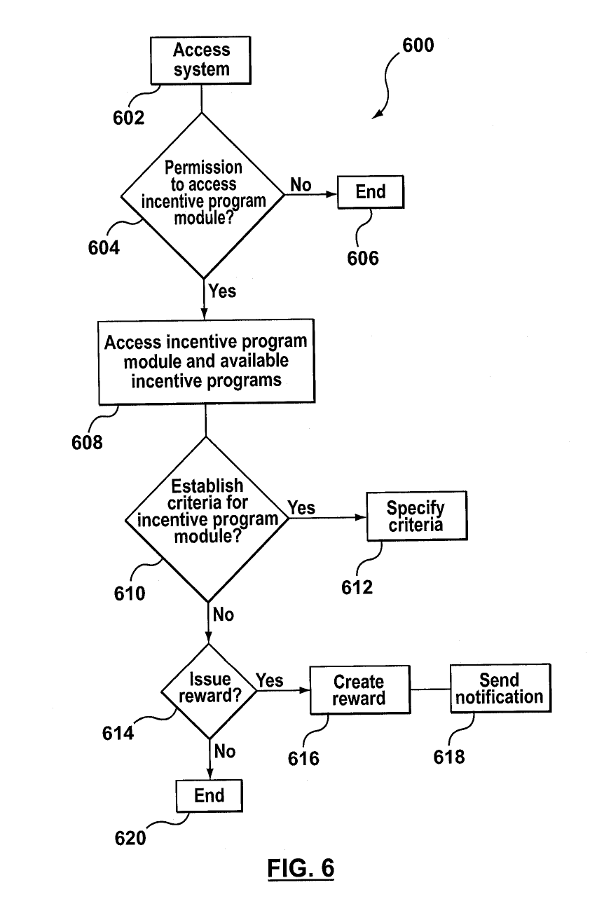

FIG. 6 (Module Access and Reward Issuance) is a flowchart for establishing incentive program criteria and issuing incentives in accordance with an embodiment of the present invention.

Process 600 allows a user, such as a superadministrator, an administrator user, or a regular user, to establish criteria for an incentive program or issue a reward under an incentive program. Such capability may be different depending on the user undertaking process 600.

Process 600 begins at 602 where system 10 is accessed, substantially as at 502 of process 500.

Process 600 continues at 604 with a query whether the user that accesses system 10 at 602 has permission to access incentive program module 50, 60. Such query may be accomplished by accessing, for example, a database of permissions in a storage at provider system 16. Accessing incentive program module 50, 60 at 604 may be accomplished, for example, by the user selecting a button from a screen of provider system 16 that they view on user system 12. Substantially all users may be able to access the incentive program module 50, 60, but such access may be different as described herein. If a user does not have permission to access incentive program module 50, 60 then process 600 ends at 606. However, if the user has such permission at 604 then process 600 continues at 608.

At 608, the user accesses incentive program module 50, 60 and available incentive programs. At 608, the available incentive programs may vary between users. For example, a superadministrator may have access to all incentive programs, an administrator user may have access to a subset of those incentive programs, and a regular user may have only certain incentive programs available to them. By way of example, a regular user may only have peer recognition incentive programs available to them at 608. The available incentive programs may be displayed to a user in a list or table. Such list or table may include only available incentive programs, or may include all incentive programs but have means to prevent access to unavailable incentive program such as by deactivating a link or requiring an authorization code.

Process 600 continues at 610 where a query is made whether the user wishes to establish criteria for incentive program module 50, 60 or incentive programs, and whether they are able to do so. System 10, and in particular provider system 16, may determine whether to allow the user to establish criteria; such determination may be initiated by a user attempting to establish criteria, such as by selecting a link on a screen of provider system 16. If a user is able to establish criteria at 610 process 600 continues at 612 where such criteria, which may be similar to other criteria discussed herein, are specified. By way of example, a superadministrator may be able to establish criteria at 610 and hence may proceed to 612. However, a regular user may not have such ability at 610 and may be required to continue to 614.

At 614 a query is made whether to issue a reward. System 10, and in particular provider system 16, may deny a user's request to issue a reward. Such may occur depending on the user attempting to issue a reward; for example, reference to an eligible award issuer database on provider system 16 may indicate whether the user can issue a reward. Every user may be able to issue at least a reward under at least an incentive program (such as a peer incentive reward). If no reward is to be issued then process 600 ends at 620. However, if a reward is to be issued, then process 600 continues at 616 where an award is created.

Creation of a reward may involve accessing available incentive programs, as set out at 608, and may further involve specifying information regarding the reward, such as a congratulatory statement, an amount of points to issue with a reward, and other attributes or characteristics relating to the reward. Such creation may further involve storing such reward, such as at provider system 16 or user system 12.

After the reward or incentive is created at 616, process 600 continues at 618 where notification is sent. Such notification may be sent to one or more of the recipient of the reward, the recipient's manager, and/or other people at the corporation or at the system operator. Such notification may be sent via email, fax, or any other way to communicate with the notification recipients, and may be sent by provider system 16, possibly automatically upon storage of the reward.

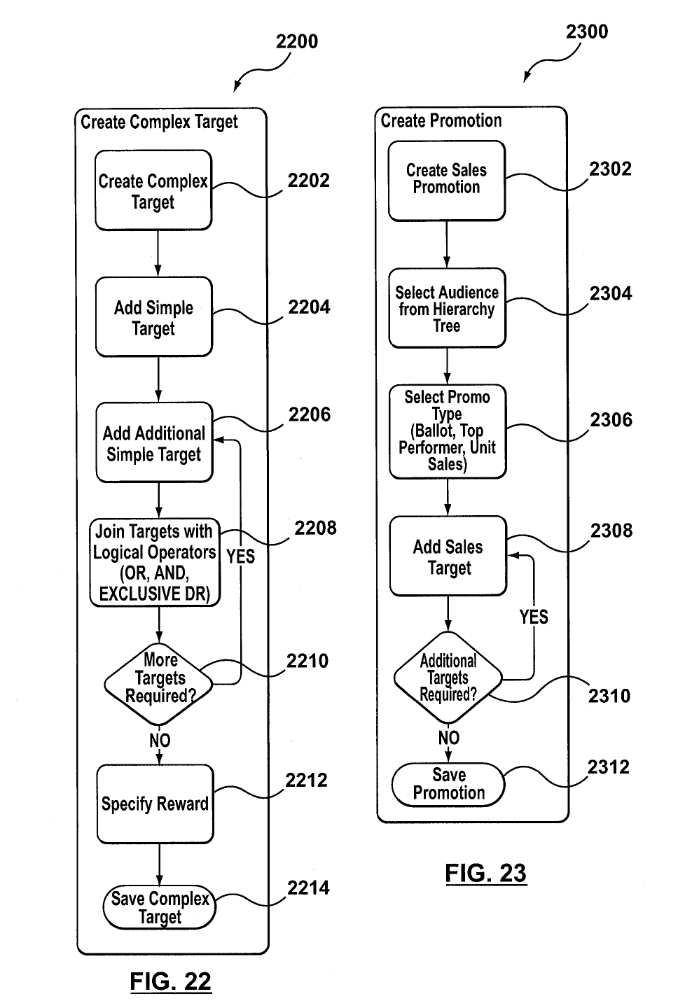

Details concerning the establishment of criteria for sales incentive programs are provided further below with reference to FIGS. 22-24. Such programs may be established as part of steps 610 and 612 of process 600 above.

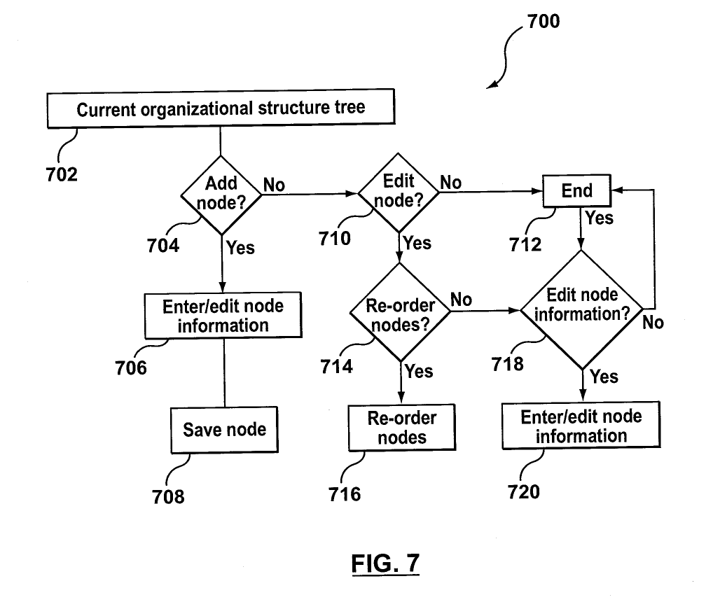

FIGS. 7-10 (Hierarchy Module) are flowcharts and screens for operation of a hierarchy module in accordance with an embodiment of the present invention.

Process 700 allows creation of a corporation's organizational structure in system 10 through use of a hierarchy module 50, 54. Hierarchy module 50, 54 may be a module 50 of system 10 that may part of provider system 16 that allows a user, or a system operator to create a corporation's structure. Such structure can be stored (such as via a linked list or other data structure), displayed and manipulated by one or more users or system operators, via user system(s) 12 or provider system 16. Operation of hierarchy module 50, 54, and in fact any other module 50, is preferably quickly responsive to users. When a user interacts with modules 50 on provider system 16, via user system(s) 12, the changes they effect, for example to organizational structure tree 760, are quickly reflected on a screen of user system(s) 12. Such responsiveness may be accomplished, for example, in real-time using Asynchronous Javascript and XML (AJaX).

Hierarchy module 50, 54 may allow a system operator to avoid being involved in administering or inputting any corporation's organizational structure for any client; this may save the system operator's time and may also save money. Hierarchy module 50, 54 allows simple addition and deletion of departments and business units, allows sub-units (for example a technical sales sub-unit under a sales unit), and allows changing the order that any of such departments, units and sub-units are presented to a user on user system(s) 12.

All, or substantially all, of process 700 may be implemented via, for example, hierarchy module 50, 54. Process 700 may be undertaken completely, or at least partially, by the superadministrator that was created at 408 in process 400. The superadministrator may undertake process 700 via user system(s) 12 accessing provider system 16. This allows system 10 to be substantially completely set up and administrated by a corporation or a user (such as a superadministrator) and not by the system operator. As discussed herein, this may save time and cost.

Referring to 702 the corporation has a current organizational structure tree in the system. The first time that process 700 occurs, the organizational structure tree may be empty or only have one node, representing the client or corporation. The organizational structure tree, therefore, may or may not entirely reflect the organizational structure of the corporation as desired by the superadministrator, and may require the addition or deletion of a node.

At 704 a query is made whether to add a node and process 700 continues at 706 if a node is to be added. At 706, node information may be entered and the node may be saved at 708. Entering node information may involve specifying a name for the node (which may relate to a division or business unit etc), a code, a manager or administrator user for the node, or other information. Saving the node at 708 may involve provider system 16 storing the node information, its position in the organizational structure, and other related information.

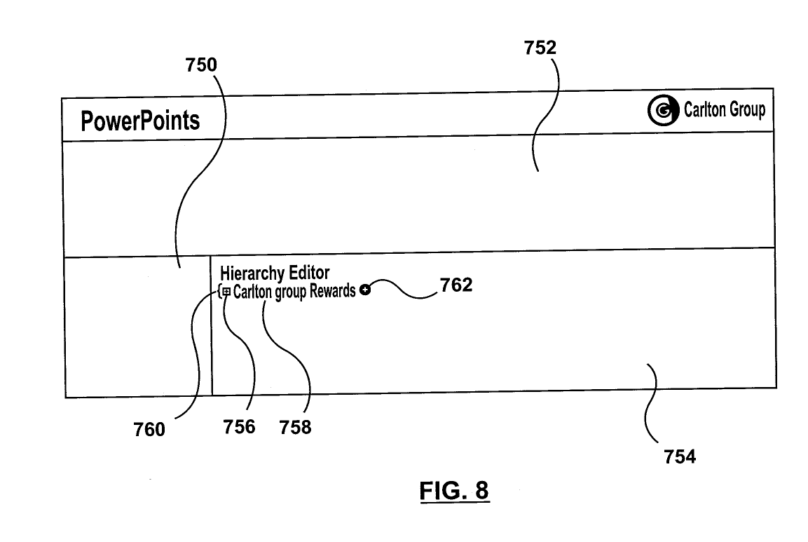

Exemplary displays for implementing 702, 704, 706 and 708 are seen at FIGS. 8-10. Such displays allow a user to view their corporation's organizational structure tree 760, add and delete nodes 764 from the organizational structure tree 760, and edit node information. FIGS. 8-10 all comprise navigation frame 750, application header frame 752, and application frame 754 which further comprises expand button 756, user identifier 758, organizational structure tree 760, and one or more nodes 764.

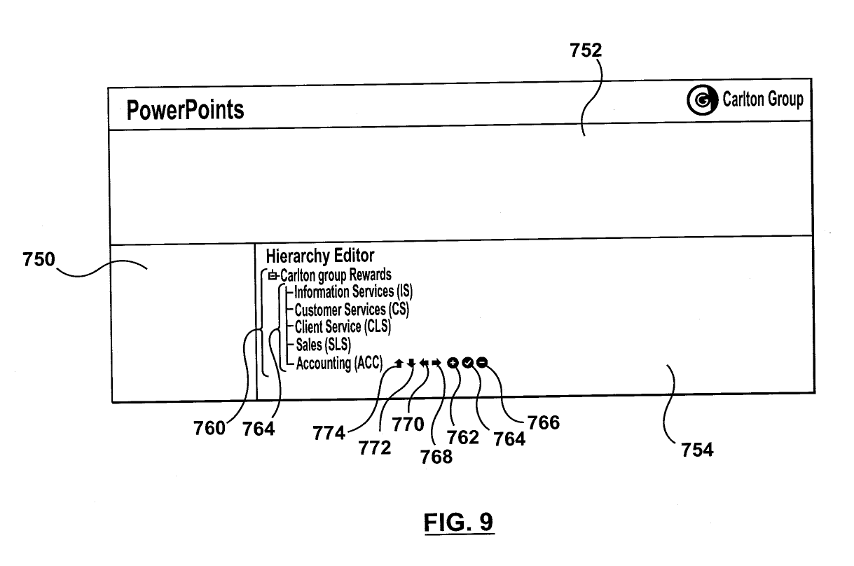

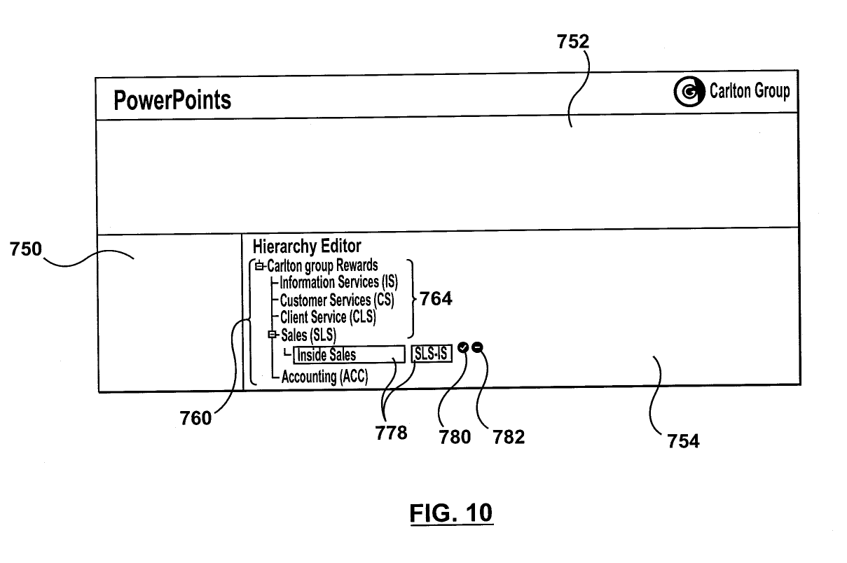

Application header frame 752 may be a configurable header frame which enhances the aesthetics of system 10 and may be configurable, for example for each client. Navigation frame 750 may allow a user to navigate through various modules 50 or sub-modules 52 of system 10 and provider system 16. Such navigation frame 750 may be substantially as is commonly found on websites. Application frame 754 may provide the location for interactions between a user and system 10—allowing a user to interact with system 10 and use the functionality of system 10. Expand button 756 may allow a user to either expand or retract organizational structure tree 760. Expand button 756 may function substantially similarly to such a button in Windows Explorer™. User identifier 758, identifies the corporation or entity whose organization is represented by organizational structure tree 760. User identifier 758 may be one of nodes 764 that are part of organizational structure tree 760 for a corporation or entity. Other divisions, departments, business units or sub-units may be other nodes—as seen in FIGS. 9-10.

FIG. 8 further comprises add node button 762. When a user selects add node button 762, as in 704 of process 700, they are able to add a node 764 to organizational structure tree 760.

FIG. 9 further comprises one or more node information edit fields 778, save node information button 780, and delete node information 782. Such node information edit fields 778 may be presented to a user after they select add node button 762 in FIG. 8. Node information edit fields 778 may be text boxes, check boxes, or other user interface elements that solicit information, which may be node information in the present case. Exemplary information that may be solicited by node information edit fields 778 includes division names, division leaders, division employees and titles, and division locations. Save node information button 780 allows a user to save node information as at 708 in process 700, which may result in provider system 16 storing information about node 764, as described herein. Delete node information 782 may allow a user to either cancel entering a new node, or delete a node that was previously added and was to be edited such as in 718 of process 700. Such deletion is not described in process 700 but is within the scope of the present invention.

In addition to elements already described, FIG. 9 further comprises move up arrow 774, move down arrow 772, decrease indent arrow 770, and increase indent arrow 768. A user may move a node up or down on application frame 754 (and possibly in storage at provider system 16) and may increase or decrease the indent of the node using decrease indent arrow 770 and increase indent arrow 768. Decreasing and increasing the indentation may indicate that a node 764 is a subsidiary, a sub-unit or is otherwise subordinate to node 764 that is directly above it.

Returning to process 700, if no new node is to be added at 704 then process 700 continues at 710 where a query is made whether nodes are to be edited. Process 700 terminates at 712 if there are no edits to be made, but continues at 714 if edits are to be made.

At 714 an inquiry is made whether to reorder nodes, proceeding to 716 if reordering is required. Reordering may involve moving a node up or down in organizational structure tree 760 or increasing or decreasing the indenting of node 764.

If at 714 there is no reordering required then process 700 continues at 718 and queries whether node information is to be edited. If no node information is to be edited then process 700 ends at 712. If node information is to be edited then process 700 proceeds to 720. Editing node information at 720 may be substantially similar to entering or editing node information at 706 and may be accomplished substantially as shown using node information edit fields 778 in FIG. 10.

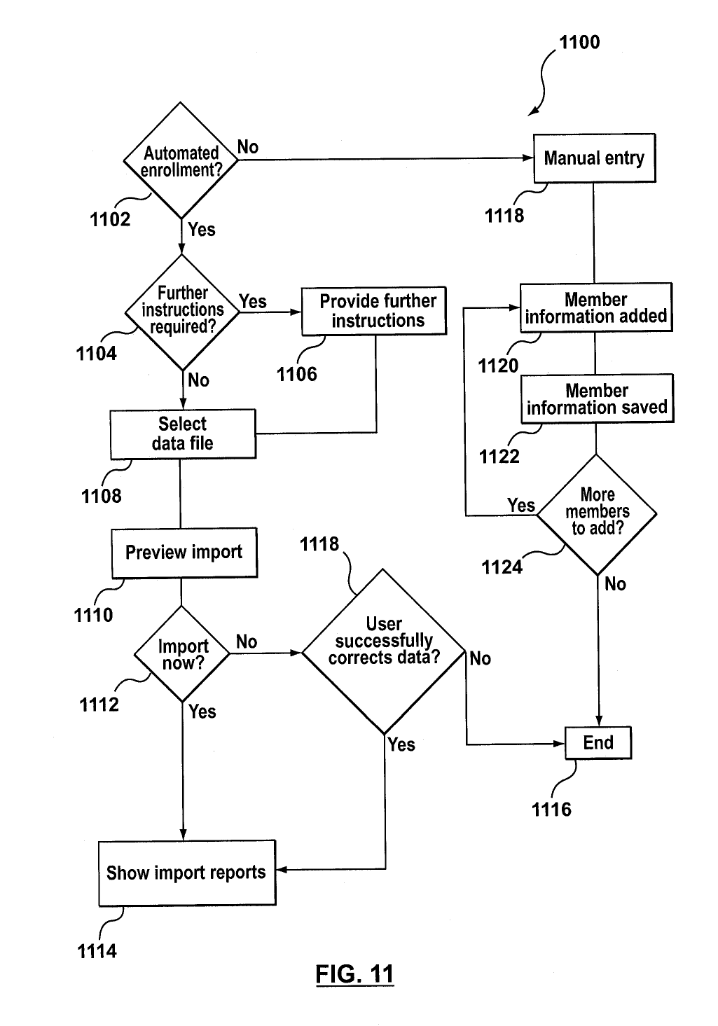

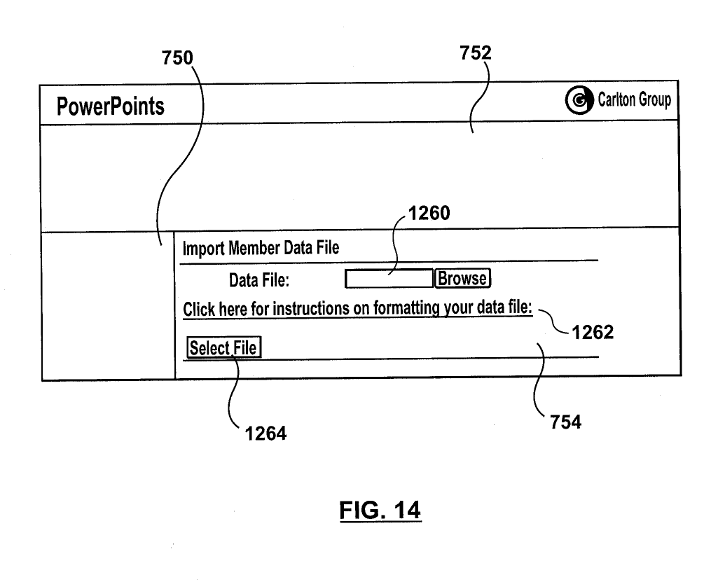

FIGS. 11-16 (Member Import) are flowcharts and screens for operation of a member enrollment module in accordance with an embodiment of the present invention.

Process 1100 allows importing or enrolling members, employees, or users into system 10 and may be implemented by enroll members module 50, 56 or hierarchy module 50, 54, any of such modules may be accessed via user system 12 and may be stored in provider system 16. Such importing or enrolling may further encompass updating employee data by importing up to date data files, parsing data in a file to add new hires, de-activating employees that have left the company by determining what employees no longer exist in a data file, and adding new fields of information for one or more employees. The new members or employees may be added automatically, such as by importing a file of employees, or by manually entering new member information. If importing a file, the user may select a properly formatted file to upload that may be stored in storage on user system 12 or use a template that assists in providing the proper format. This assistance may, for example, map fields in a file to characteristics of the employee that are to be stored (such as the nodes or divisions they are in, incentives they are eligible for, personal data, etc). Process 1100, and any modules that may implement it, may also validate the data file, rejects any incomplete data files, and provide an explanation of such rejection. This validation processing may be done, for example, by provider system 16 or user system 12. Users may then view rejected files and edit them directly on screen, such as at user system 12, to allow importing or increase the amount of data, or employees, that is successfully imported.

Although any user from either the system provider or the client corporation can import new members, it may be one or more of a corporation's administrators or superadministrator to increase system's 10 automation. As discussed herein, this may save the system operator's time and may save cost. Imported members can be added to one or more divisions and can have various member information associated with them. This may occur via information in the selected file, or may occur via information that is entered manually.

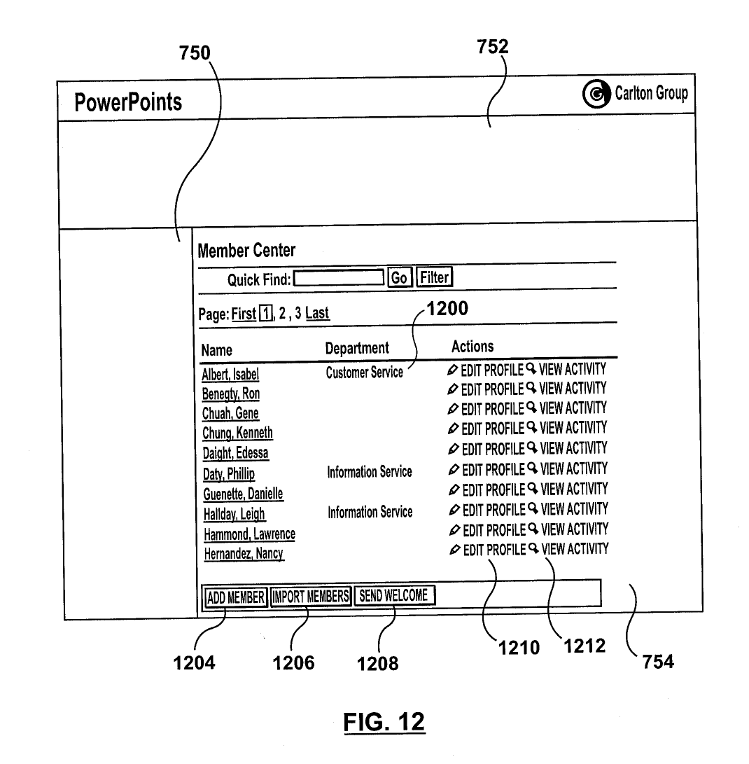

Process 1100 begins at 1102 with a query whether automated entry is desired, and proceeds to 1104 process if it is. As further described herein, a positive indication at 1102 may be indicated via import members button 1206 on the screen in FIG. 12, which may be stored at provider system 16 and accessed by a user at user system 12.

FIG. 12 comprises application header frame 752, application frame 754 and navigation frame 750, as described herein. Application frame 754, in FIG. 12, further comprises users/members 1202, fields 1200, view activity link 1212, edit profile link 1210, add member button 1204, import members button 1206 and send welcome button 1208.

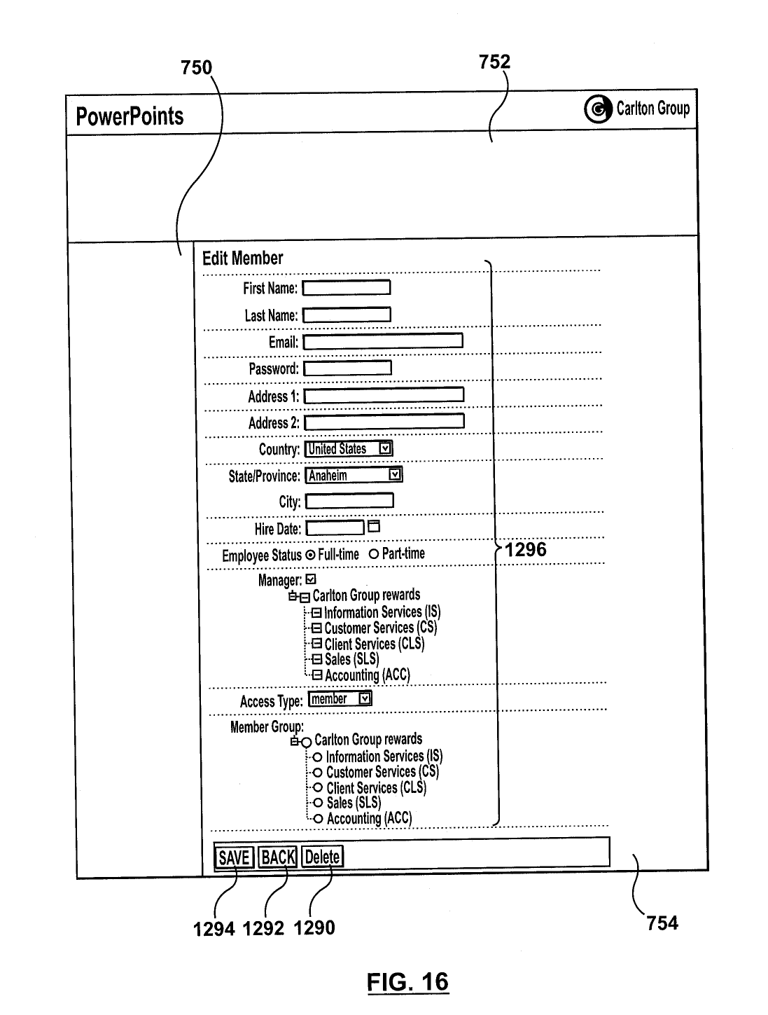

Users/members 1202 displays current users or members. Each user or member has one or more fields 1200 that contain information about that user or member. Edit profile link 1210, when selected, allows a user's profile to be edited. Such editing may be accomplished, for example, via the screen in FIG. 16, as described herein. View activity link 1212 may allow viewing a user or member's activity, which may include points received or redeemed, changes in their profile, addition to different divisions, or other such activity. Add member button 1204 allows manually adding a user, such as in 1118 and 1120 in process 1100. Import members button 1206 may indicate that automated entry is desired, as at 1102 in process 1100. Send welcome button 1208 may be used to send a welcome greeting to one or more users or members. Such welcome may be, for example, an email or message through the system.

Process 1100 continues at 1104 where a user may require further instructions regarding automated importing of members or users. By way of example, a user may be uncertain of the file format that is required, an acceptable file size, other characteristics about the file to be imported, or the process for doing so. If the user does require further instructions then process 1100 continues to 1106 where a user is provided further instructions that may assist.

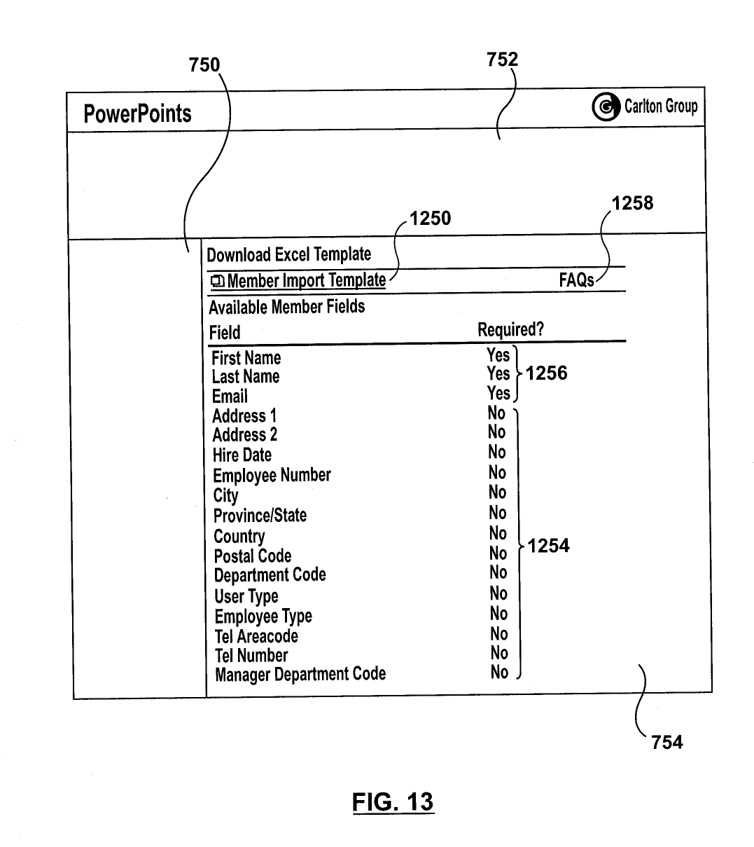

An exemplary screen for implementing 1106 can be seen at FIG. 13; such screen may be stored or created at provider system 16 and accessed at user system 12. FIG. 13 comprises application frame 754, navigation frame 750, and application header frame 752, which may be substantially as described herein.

Application frame 754, in FIG. 13, further comprises sample file 1250, other instructions 1258, required field indicator 1256, optional field indicator 1254 and one or more fields 1252. Sample file 1250 may be a file that a user can download or open to see a template that would successfully import new members according to process 1100. As shown in FIG. 13, such file may be an Excel™ file or may be in any format, and may have any name. Sample file 1250 may be a static file, or may be dynamically created in response to a user indicating, for example using configurable required field indicators (not shown), what fields they would like to be able to import. Such a dynamically created file would allow a user to see a template, based on their desired fields, that would be successfully imported. Further, a user may be able to modify data in a template or add their data to a template and then modify it. This may be done to make the template, and data, more relevant for the particular client, or to conform the data to the template prior to selecting the file.

Other instructions 1258 may be a link to, for example, frequently asked questions (FAQs) relating to instructions for automated entry via a data file. In another embodiment other instructions 1258 may include text that provides frequently asked questions or other such information directly in FIG. 13. Other instructions 1258 may include instructions other than relating to importing a file.

Fields 1252 provides a non-exclusive list of member information that may be a field in the file to be uploaded to add new members. Required field indicator 1256 may be used to indicate which of fields 1252 must be included in any file that is uploaded. As shown in FIG. 13, a file for uploading requires first name, last name and email fields. It is to be understood that any of fields 1252 may be required and that other fields 1252 are possible, and may be required or optional. Additionally, fields 1252 that are optional may be configurable by one or more of an administrator, superadministrator or system operator, for each client. Optional field indicator 1254 indicates that the fields 1252 are not required for successful uploading of a file.

Returning to process 1100, it continues at 1108 where a data file is selected. This selection may be by using a file selection pop-up window viewed at user system 12 (not shown), as is customary with software or Internet applications. The user may select a specific file, or a plurality of files, and indicate, for example by clicking an “Okay” button (not shown), that those one or more files are to be uploaded.

After a data file has been selected at 1108, process 1100 continues at 1110 where the import can be previewed such as by provider system 16 preparing a preview screen and allowing it to be accessed at user system 12. In order to provide a preview, system 10 may process the data file and format it for presentation. Such processing may involve reading the selected data file and putting it into, for example, a multidimensional array and mapping field names in the sample file (such as a header row from an Excel™ file) to fields 1252. Then, members or users that are in the selected data file may be stored, at provider system 16, such as in data structures for members or users having elements relating to each field 1252.

Previewing the import may comprise showing a screen with the data as imported to allow user to determine whether the import has been successful. The success of the import may be based on, for example, the extent to which the data file selected adheres to the template as shown at 1106. System 10 may provide statistics or analysis to indicate to a user that is uploading a file how successful the uploading was. Alternatively, a user may simply view the preview and determine for themselves whether the uploading was adequate or not.

At 1112 process 1100 queries whether to import the file or not. A user may respond to this query, for example by selecting an import button or an okay button for example.

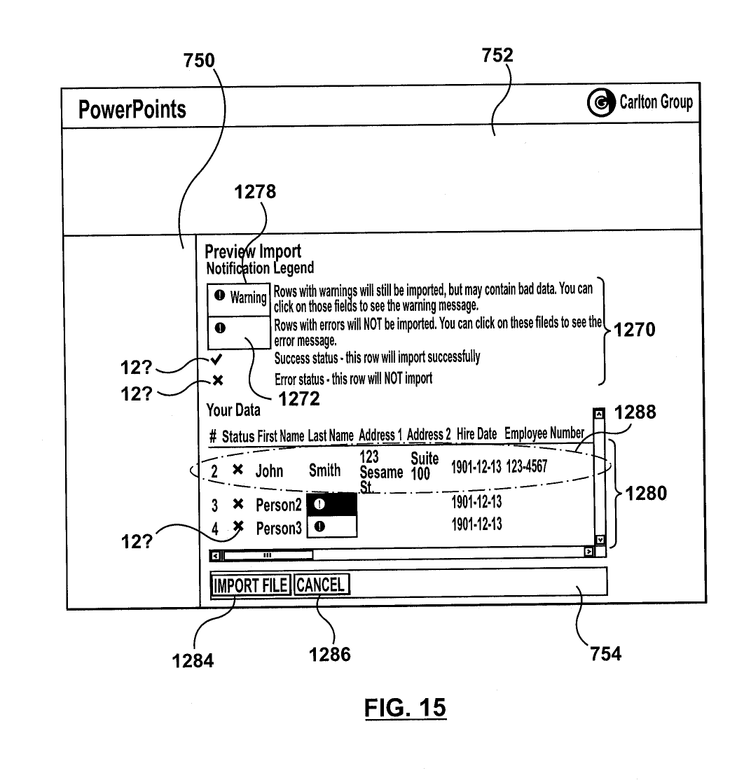

An exemplary screen for previewing the import and for indicating whether to import is shown in FIG. 15; such screen may be stored or created at provider system 16 and accessed at user system 12. FIG. 15 comprises application frame 754, navigation frame 750, and application header frame 752. Application header frame 752 and navigation frame 750 may be substantially as described herein.

FIG. 15 further comprises notification legend 1270, previewed imported data field 1280, import button 1284 and cancel button 1286. Notification legend 1270 provides an explanation of indicators 1272, 1274, 1276, 1278 that may be used in as row indicators 1282 in imported user/member 1288 to show the status of each of the one or more members to be added from the selected file.

Indicators may include warning indicator 1278, error indicator 1276, success indicator 1274 and error with explanation indicator 1272. Warning indicator 1278 indicates that the data will be imported but some data may be improper. Further information can be obtained by a user selecting warning indicator 1278. Error with explanation indicator 1272 indicates that data will not be imported. A user may select error with explanation indicator 1272 to see more information. Success indicator 1274 indicates that a member in a row in the selected file will import successfully. Error indicator 1276 indicates that a member in a row in the selected file will not be imported successfully, but no further information is available.

Previewed imported data field 1280 displays data from the selected file that is to be imported, and row indicator 1282 that indicates the success of each imported user/member 1288 in the selected file. A user may review previewed imported data field 1280 to determine whether the selected file will be adequately successfully uploaded. A user may further be able to edit the data in previewed imported data field 1280 to correct errors that may have occurred in importing. This may be, for example, via text boxes, drop-down menus, or other user interface components known in the art and forming at least a part of previewed imported data field 1280.

Import button 1284 allows a user to indicate that they want to continue the process of importing the data file to create new members, as in process 1100 at 1112. Selecting import button 1284 may indicate, for example, that a user is satisfied with the previewed imported data field 1280. Cancel button 1286 may indicate that the user is not satisfied with previewed imported data 1280. Selection of cancel button 1286 may return a user to restart process 1100 and may lead the user to alter the selected file they wish to import.

Returning to process 1100 at 1112 if the import is to occur, then at 1114 process 1100 shows import reports. Such reports may be substantially as in FIG. 12 and further described herein. Additionally, import reports may provide statistics or other characteristics relating to the addition of members.

Returning to 1112 if the import is not to occur now then process 1100 continues at 1118 where a user may attempt to correct errors that occurred in importing the selected file. This may be accomplished, for example, via previewed imported data field 1280 on the screen in FIG. 15, as described herein. A user may attempt to correct one or more errors and not be successful, at which point process 1100 may proceed to 1116, such as if cancel button 1286 in FIG. 15 was selected. Alternatively, a user may correct all errors, or a portion of the errors, allowing successful importing and/or making importing desirable. Process 1100 may then proceed to 1114, such as via the user selecting import button 1284, as described herein.

Returning to 1102, if automated entry is not required, process 1100 continues at 1118 where manual entry occurs. The user may initiate manual entry, for example by selecting a button or function with system, as with add member button 1204 in FIG. 12, as described herein. At 1120 member information is added manually. Such manual entry may be in substantially any manner as would be apparent to a person of skill in the art. An exemplary screen for such manual entry is shown in FIG. 16, and described herein.

At 1122 the added member information may be saved and the member is then added. Saving the member information at 1122 may involve, for example, storing such information at provider system 16. At 1124 process 1100 queries whether there are more members to add. If so, process 1100 returns to 1120 to add further member information. If at 1124 there are no further members to add then process 1100 ends at 1116.

The addition of member information, saving such information, and indicating whether there are more members to add, may be accomplished, for example using the screen in FIG. 16; such screen may be stored or created at provider system 16 and accessed at user system 12. FIG. 16 comprises application frame 754, navigation frame 750, and application header frame 752. Application header frame 752 and navigation frame 750 may be substantially as described herein.

Application frame 754, in FIG. 16, further comprises member information field 1296, save button 1294, back button 1292 and delete button 1290. Member information fields 1296 allow adding member information via one or more fields. The fields may be text boxes, selection boxes or other user interface items. Save button 1294 allows the member to be added by saving the member information in member information fields 1296. Back button 1292 returns a user to a previous screen and does not save any member information that has been changed in member information fields 1296. Delete button 1290 may delete the member currently displayed in member information fields 1296.

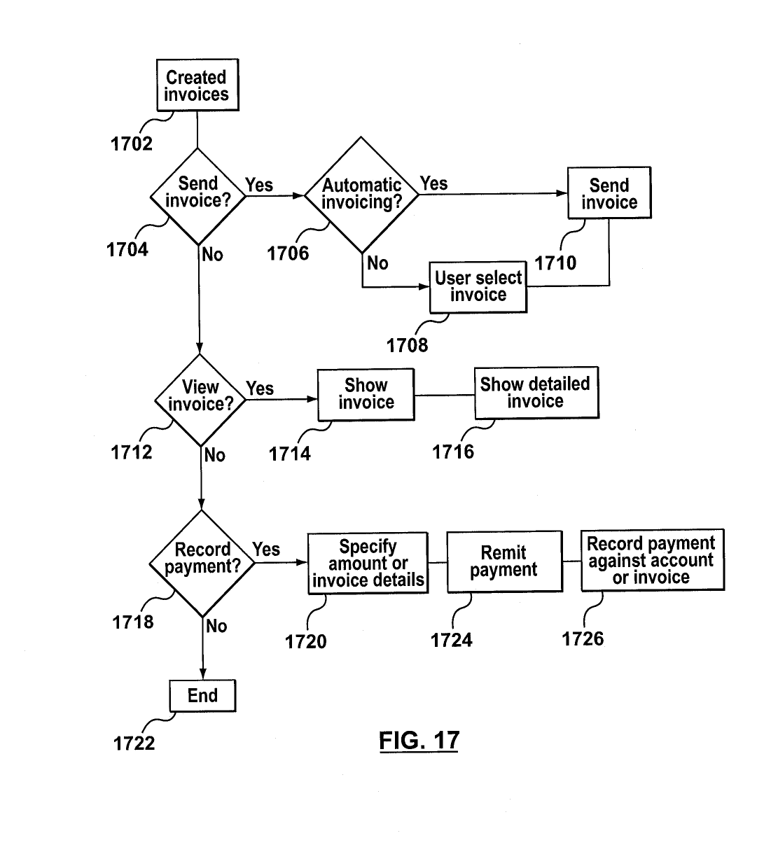

FIGS. 17-20 (Invoicing System) are flowcharts and screens for an invoicing module 50, 58 in accordance with an embodiment of the present invention.

Process 1700 in FIG. 17 shows the operation of an invoicing module 50, 58 according to an embodiment of the invention which may be stored at, and operate from, system provider 16 or user system 12. Invoicing module 50, 58 can operate without any intervention by the system provider or it can operate with limited or substantial intervention by a system provider or user of system 10. Invoicing module 50, 58, and the amount of an invoice, may be based on, for example, the number of points a corporation has issued to its users, a number of awards or rewards given or redeemed, an amount of time that the corporation has used the system, or any other criteria.

Process 1700 begins at 1702 with creation of one or more invoices. Creation of the invoices may occur as often as desired, at any time of the day or night and may be done using a batch system. By way of example, invoices may be created, for all clients, at 12:00 a.m. on the first day of every month. It is to be understood that the creation of invoices may be one or more invoices for one or more clients for one or more periods. Such creation may be accomplished, for example, by provider system accessing one or more databases, either local or remote, that allow filling out a dynamic invoice web page of document template.

After invoices are created at 1704, process 1700 queries whether to send one or more invoices such as referring to a database of preferences, that may be stored at provider system 16 and may indicate invoicing preferences or timing, for example. If invoices are to be sent then process 1700 continues to 1706 where process 1700 queries clears whether sending of the one or more invoices is by automatic invoicing. By way of example, system 10 may be configured to send invoices automatically to one or more clients based on one or more criteria, such as a day, after a number of points are issued, after a total amount owing has reached a limit, or other such criteria. A corporation may only be allowed to issue a certain number of points, for example, before access to system 10 is denied. This number may be based, at least partially, on a credit check for example.

If sending at 1704 is automatic sending at 1706, then at 1710 the one or more invoices are sent. The sending of the invoice may be, for example, by electronic means such as fax or email and may be done by provider system 16. Additionally, invoices may be sent by mail or other non-electronic means, or a combination thereof.

If sending is not automatic, the user, such as a system provider or superadministrator, selects one or more invoices to send at 1708.

It is to be understood that at 1708 and 1710 the one or more invoices may be unpaid invoices, unsent invoices, invoices that have already been paid, or any combination thereof.

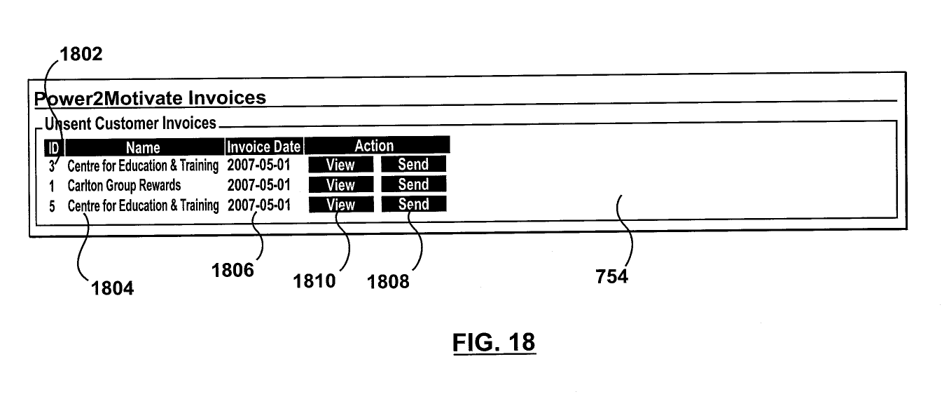

Referring to FIG. 18, an exemplary screen of a list of invoices is shown; such screen may be stored or created at provider system 16 and accessed at user system 12. Such display comprises application frame 754 which, in FIG. 18, further comprises customer identifier 1804, invoice date 1806, invoice ID number 1802, view invoice button 1810, and send invoice button 1808. It is to be understood that FIG. 16 may further comprise application header frame 752 and navigation frame 750.

Customer identifier 1804, invoice date 1806, and invoice ID number 1802 may uniquely identify an invoice—either separately or in some combination. View invoice button 1810 allows a user to view a selected invoice, as at 1714 in process 1700. Send invoice button 1808 initiates sending of the invoice as at 1710 in process 1700.

Returning to process 1700, if invoices are not to be sent at 1704 then at 1712 process 1700 queries whether invoices are to be viewed such as by a user, at user system 12, indicating they wish to review an invoice. If so, process 1700 continues to 1714 where an invoice is shown. The invoice that is shown at 1714 may be unpaid invoices, unsent invoices, already paid invoices, or any combination thereof. Process 1700 may proceed to 1716 and show a detailed invoice, though such is not required. At 1716, further details about the invoice shown at 1714 may include who incurred the costs, the date on which such costs were incurred, and any further detailed information.

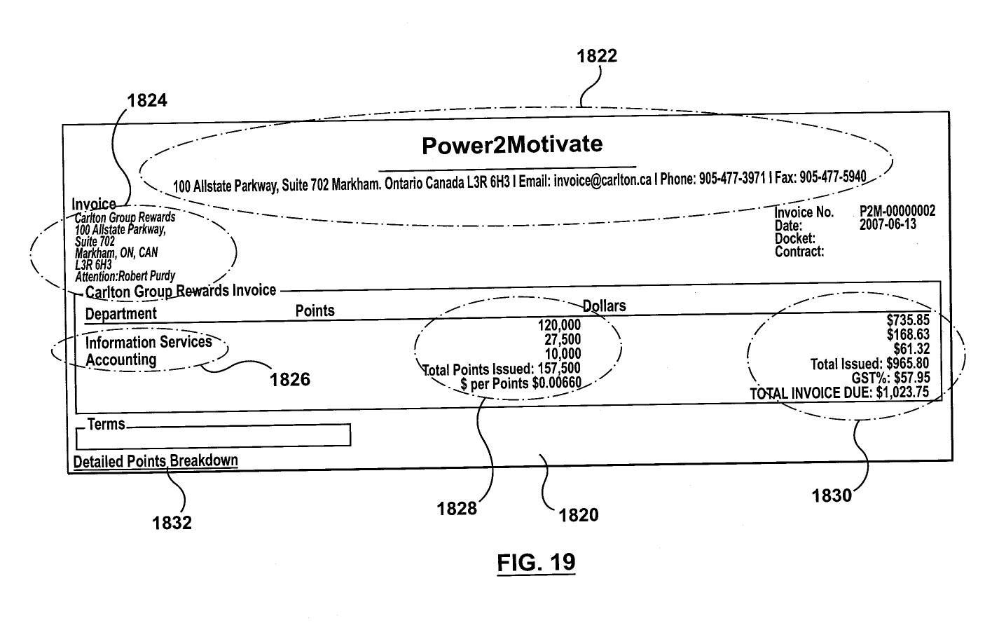

Returning briefly to FIG. 18, if view invoice button 1810 is selected by a user then an invoice is shown as at 1714. View invoice button 1810 may cause an invoice, such as exemplary invoice 1820 in FIG. 19 to be shown, in accordance with 1714 of process 1700.

Invoice 1820 comprises system provider information 1822, client information 1824, itemized invoice elements 1826, points information 1828, amounts owed information 1830 and detailed breakdown link 1832.

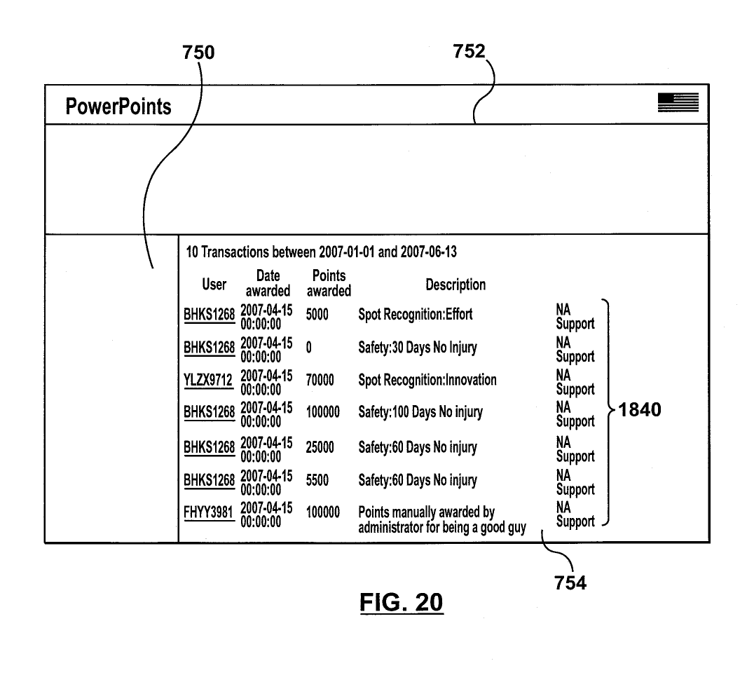

System provider information 1822 may be used to identify the system provider, to whom payment is owed. Client information 1824 may identify the party to whom the invoice is issued. Itemized invoice elements 1826 may indicate a detailed breakdown of the elements of invoice 1820. Points information 1828 may include a number of points allocated for each of the itemized invoice elements 1826 and may further provide a conversion between points and dollars. Amounts owed information 1830 may provide dollar amounts, including subtotals, taxes and totals, that form the amount that is owed for the invoice. Detailed breakdown link 1832 may be a link that the user may select when the invoices presented electronically to view a more detailed breakdown of invoice 1820, as in FIG. 20.

FIG. 20 shows a detailed breakdown comprising navigation frame 750, application header frame 752, and application frame 754 which, in FIG. 20, further comprises detailed invoice information 1840; such detailed invoice information may be stored at provider system 16 and may be made into a detailed invoice by provider system 16. Detailed information 1840 may provide, for example, the user that awarded the incentive or that was awarded the incentive, the date such incentive was awarded, the number of points awarded, and the description of the incentive program or incentive that was given to such user. It is to be understood that detailed invoice information 1840 as shown in FIG. 20 is exemplary only and other detailed information 1840 may be included or may replace such information as shown in FIG. 20.

Returning to process 1700, if no invoice is to be viewed at 1712 then process 1700 continues at 1718 where process 1700 queries whether to record a payment. If a payment is to be recorded at 1718 then process 1700 continues to 1720 where an account or invoice details are specified. The account or invoice details specified at 1720 allow a payment to be associated with a specific account or invoice. Any information allowing such association is considered within the scope of the present invention. After specifying an account or invoice details at 1720, process 1700 continues to 1724 where payment is remitted.

Payment may be remitted by a corporation by providing a cheque, providing a credit card number electronically or in another way, or any other form of making a payment, such as in a typical e-commerce transaction. Remitting payment at 1724 may further include a preauthorized transaction such as a a debit transaction, a credit transaction, or any other transaction where payment is automatically or pre-emptively made against an account or invoice.

Process 1700 then proceeds to 1726 where the received payment is applied against the account or invoice specified at 1720. If, at 1718, no payment is to be recorded then process 1700 ends at 1722.

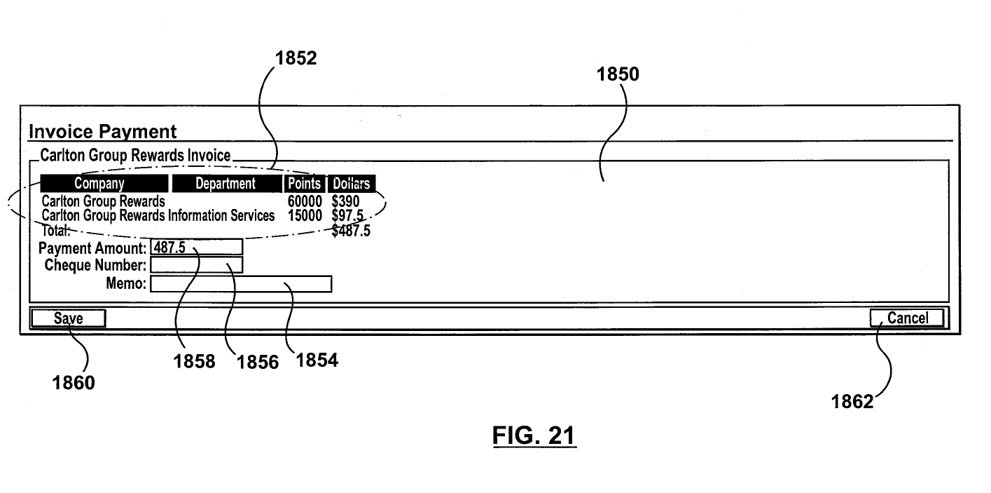

Referring to FIG. 21, an exemplary screen for recording a payment is shown; such screen may be stored or created at provider system 16 and accessed at user system 12. Payment recording screen 1850 comprises account or invoice details 1852, payment amount 1858, payment remittance source 1856, memo 1854, save payment button 1860 and cancel payment button 1862.

Account or invoice details 1852 specify an account or invoice against which the payment is to be made. Payment amount 1858 indicates an amount to apply against the account or invoice that is specified in account or invoice detail 1852. Payment remittance source 1856 may indicate the source of the payment, or may actually provide the payment itself. By way of example, payment remittance source 1856 may be a cheque number that a user may enter when a cheque is received for example in the mail. In an alternative embodiment, payment remittance source 1856 may be a credit card number and other information required to process a credit card transaction. In such an embodiment a verification may be performed when save payment button 1860 is selected, and verification of the credit card information and ability to pay may be made. Memo 1854 may be a field that can be used to add details about a particular payment. Save button 1860 allows system 10 to record payment of the payment amount 1858 against the account or invoice, as at 1726 in process 1700. Cancel payment button 1862 cancels the payment and may cause process 1700 to end at 1722.

FIG. 22 (Create Complex Target) is a flowchart for establishing sales incentive program criteria and issuing incentives in accordance with an embodiment of the present invention.

Process 2200 allows a user, such as a superadministrator or an administrator, to establish criteria for a sales incentive program having a complex target comprising a number of adjoined simple targets. The capability to establish the program may be different depending on the user undertaking process 2200.

Process 2200 begins at 2202 where complex target criteria is established,

Process 2200 continues at 2204 where a first simple target is added and at 2206 where an additional simple target is added. Examples of simple targets include: (i) Example 1: Sell ten units of product A during the month of September and earn 10,000 points and (ii) Example 2: All sales people at retail store X earn 5,000 points if retail store X sells 100 units of product A during the month of September.

Process 2200 continues at 2208 where the first and additional simple targets are joined using specified logical operators (such as OR, AND, and EXCLUSIVE OR). Examples of adjoined simple targets (i.e. complex targets) include: (i) Example 1: Sell ten units of product A during the month of September and earn 10,000 points AND earn additional 15000 points for selling eight units of product A by September 15 and (ii) Example 2: Earn 200 points for each of product A sold during Q3 AND earn 1800 additional points per sale of product A if retail store sells 1000 units of product A during Q3.

Process 2200 continues at 2210 where a query is made whether the user wishes to add more simple targets. If a user affirms that it wishes to add more simple targets the process returns to 2206 where the user can add an additional simple target and then 2208 where the simple targets are joined with logical operators and 2210 when the user is queried whether it wishes to add more simple targets.

Process 2200 continues at 2212 once the user indicates that it does not wish to add more simple targets. At 2212 user specifies a reward for achievement of the complex target and at 2214 where the created complex target is saved.

FIG. 23 (Create Promotion) is a flowchart for establishing sales incentive program criteria and issuing incentives in accordance with an embodiment of the present invention.

Process 2300 allows a user, such as a superadministrator or an administrator to establish criteria for a sales promotion. The capability to establish the program may be different depending on the user undertaking process 2300.

Process 2300 begins at 2302 where a sales promotion is established.

Process 2300 continues at 2304 where a user selects an audience from a hierarchy tree such as provided at 702 in process 700. The audience may be those members that are making eligible sales and can participate in the promotion.

Process 2300 continues at 2306 where a user selects a promotion type such as ballot, top performer or unit sales. Ballot promotions award users ballots for reaching a target. At the end of the promotion a draw from the accumulated ballots will occur to award prizes based on the promotion rules. Top performer promotions will award promotion ranking points based on target criteria. At the end of the promotion the top X users based on total ranking points will be awarded a designated point award value. Unit sales promotions award users based on units sold.

Process 2300 continues at 2308 where a user selects a sales target. The selected target may be either a simple or complex target that was previously defined in process 2200

Process 2300 continues at 2310 where a query is made whether user wishes to add more sales targets. If a user affirms that it wishes to add more sales targets the process returns to 2308 where the user can add an additional sales target and then 2310 when the user is queried whether it wishes to add more sales targets.

Process 2300 continues at 2312, once the user indicates that it does not wish to add more sales targets, at which point the created sales promotion is saved.

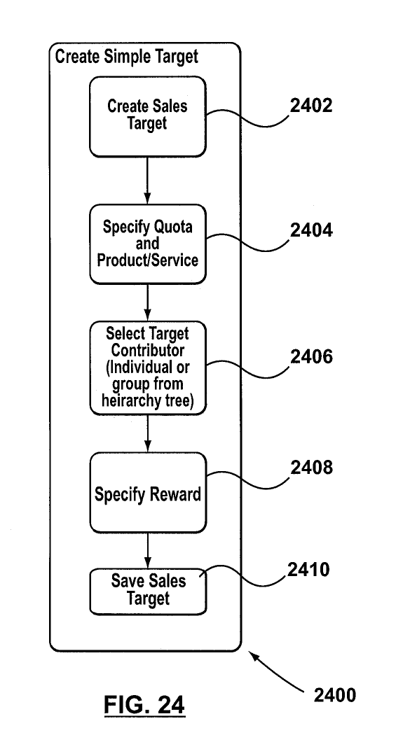

FIG. 24 (Create Simple Target) is a flowchart for establishing sales incentive program criteria and issuing incentives in accordance with an embodiment of the present invention.

Process 2400 allows a user, such as a superadministrator or an administrator, to establish criteria for a simple sales target. The capability to establish the program may be different depending on the user undertaking process 2400.

Process 2400 begins at 2402 where sales target criteria is established.

Process 2400 continues at 2404 where quota and product/service criteria are specified. Examples of such criteria include: (i) Example 1: quota=5 and product/service=product A (in other words sell 5 drills) and (ii) Example 2: quota=10 and product/service=product B (in other words sell ten of model year 2008 Subaru Impreza WRX).

Process 2400 continues at 2406 where the target contributor is specified (such as an individual or a group selected from the hierarchy tree such as provided at 702 in process 700). A contributor may be a sales person or group of sales persons (ie a retail store) whose sales are aggregated and counted towards targets established in process 2200.

Process 2400 continues at 2408 where the reward is specified and then 2410 where the criteria is saved.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

1-7. (canceled)

8. A method for a provider to enable authorized users from a plurality of client organizations to create and manage incentive programs that are specific to each client organization, comprising the steps of:
providing a provider system coupled to a communication network for access by a plurality of authorized users associated with a plurality of client organizations;
providing a hierarchy module adapted for receiving and managing information from authorized users concerning the organizational structure of each client organization, said information being organized into nodes of a data structure with each node corresponding to a desired structural component or subcomponent of the client organization;
providing an incentive module adapted for receiving and managing information from authorized users to enable said authorized users to create and manage concerning one or more incentive programs associated with one or more nodes for each client organization; and
providing a permissions module adapted for receiving and managing information concerning the authorized users from each said client organization, said information including username and password information for each authorized user as well as information concerning the scope of access to the system permitted to each authorized user including access to one or more of said modules and nodes within said system.

9. A method as claimed in claim 8 wherein said hierarchy module includes inputs adapted for receiving data concerning personnel of the client organization.

10. A method as claimed in claim 8 wherein said incentive module includes inputs adapted for receiving sales target criteria and one or more rewards for a designated incentive program.

11. A method as claimed in claim 10 wherein said sales target criteria includes a plurality of sales targets joined using specified logical operators.

12. A method as claimed in claim 10 wherein said hierarchy module includes inputs adapted for receiving data from an authorized user concerning personnel of the client organization and wherein said incentive module includes inputs adapted for associating said sales target criteria with one or more of said personnel.

13. A method as claimed in claim 8 further comprising an automated invoicing module adapted for automatically issuing invoices to a client organization based upon predefined criteria relating to the client organization's use of the system.

14. A method as claimed in claim 13 wherein said predefined criteria includes rewards issued to personnel of the client organization through the incentive programs.

15. A computer implemented system that is accessible over a communication network by a plurality of authorized users associated with a plurality of client organizations to create and manage incentive programs that are specific to each client organization, the system comprising:
a hierarchy module adapted for receiving and managing information from authorized users concerning the organizational structure of each client organization, said information being organized into nodes of a data structure with each node corresponding to a desired structural component or subcomponent of the client organization;
an incentive module adapted for receiving and managing information from authorized users to enable said authorized users to create and manage one or more incentive programs associated with one or more nodes for each client organization; and
a permissions module adapted for receiving and managing information concerning the authorized users from each said client organization, said information including username and password information for each authorized user as well as information concerning the scope of access to the system permitted to each authorized user including access to one or more of said modules and nodes within said system.

16. A system as claimed in claim 15 wherein said hierarchy module is adapted for receiving data concerning personnel of the client organization.

17. A system as claimed in claim 15 wherein said incentive module is adapted for receiving sales target criteria and one or more rewards for a designated incentive program.

18. A system as claimed in claim 16 wherein said sales target criteria includes a plurality of sales targets joined using specified logical operators.

19. A system as claimed in claim 15 wherein said hierarchy module is adapted for receiving data from an authorized user concerning personnel of the client organization and wherein said incentive module is adapted for associating said sales target criteria with one or more of said personnel.

20. A system as claimed in claim 15 further comprising an automated invoicing module adapted for automatically issuing invoices to a client organization based upon predefined criteria relating to the client organization's use of the system.

21. A system as claimed in claim 20 wherein said predefined criteria includes rewards issued to personnel of the client organization through the incentive programs.

22. A method for an authorized user of a client organization to create and manage an incentive program for said client organization, said method comprising the steps of:
accessing a provider system through a communication network, said provider system being adapted to receive and manage information for a plurality of client organizations;
entering and managing information onto said provider system concerning the organizational structure of said client organization, said information being organized into nodes of a data structure with each node corresponding to a desired structural component or subcomponent of the client organization; and
entering and managing information onto said provider system to enable said authorized users to create and manage one or more incentive programs associated with one or more nodes for said client organization; and
entering and managing information onto said provider system concerning the authorized users from each said client organization, said information including username and password information for each authorized user as well as information concerning the scope of access to the system permitted to each authorized user including access to one or more of said modules and nodes within said system.

23. A method as claimed in claim 22 further comprising the step of entering and managing information onto said provider system concerning personnel of the client organization.

24. A method as claimed in claim 22 wherein said incentive program information includes sales target criteria and one or more rewards for a designated incentive program.

25. A method as claimed in claim 24 wherein said sales target criteria includes a plurality of sales targets joined using specified logical operators.

26. A method as claimed in claim 24 further comprising the step of entering and managing information onto said provider system concerning personnel of the client organization and wherein said incentive program information includes inputs adapted for associating said sales target criteria with one or more of said personnel.

27. A computer readable storage medium with instructions stored thereon for enabling a provider system to receive and manage information provided by one or more authorized users from a plurality of client organizations over a communication network to create and manage incentive programs that are specific to each client organization, the instructions comprising:
providing a hierarchy module adapted for receiving and managing information from authorized users concerning the organizational structure of each client organization, said information being organized into nodes of a data structure with each node corresponding to a desired structural component or subcomponent of the client organization;
providing an incentive module adapted for receiving and managing information from authorized users to enable said authorized users to create and manage one or more incentive programs associated with one or more nodes for each client organization; and
providing a permissions module adapted for receiving and managing information concerning the authorized users from each said client organization, said information including username and password information for each authorized user as well as information concerning the scope of access to the system permitted to each authorized user including access to one or more of said modules and nodes within said system.

28-33. (canceled)
